(19) United States
(12) Patent Application Publication
(10) Pub. No.: US 2016/0084318 A1
(43) Pub. Date: Mar. 24, 2016

(54) DAMPER DEVICE

(71) Applicants: Yukinobu NISHIKAWA, Anjo-shi (JP); Satoshi KASAMAI, Miyoshi-shi (JP); Kenji ODAKA, Toyota-shi (JP)

(72) Inventors: Yukinobu NISHIKAWA, Anjo-shi (JP); Satoshi KASAMAI, Miyoshi-shi (JP); Kenji ODAKA, Toyota-shi (JP)

(73) Assignee: TOYOTA JIDOSHA KABUSHIKI KAISHA, Toyota-shi, Aichi (JP)

(21) Appl. No.: 14/888,784

(22) PCT Filed: May 10, 2013
(86) PCT No.: PCT/JP2013/063194

§ 371 Date: Nov. 3, 2015

(51) Int. Cl. F16D 3/12; F16F 15/121

(52) U.S. Cl. CPC F16D 3/12; F16F 15/1213

(57) ABSTRACT

A damper device disposed on a drive power transmission path between an engine and an electric motor in a power transmission device including the engine and the electric motor, the damper device comprising a first inertia member coupled to a shaft of the engine; a first plate coupled to the first inertia member; a second plate coupled to the electric motor and disposed rotatable relative to the first plate; a third plate coupled via a torque limiter to the second plate; and a damper spring disposed on a drive power transmission path between the third plate and the first plate, the torque limiter being disposed with a second inertia member located on the outer circumferential side of the first inertia member and radially overlapping with the first inertia member in the overall width dimension of the first inertia member in an axial direction thereof.

### TECHNICAL FIELD

The present invention relates to a damper device disposed on a drive power transmission path between an engine and an electric motor and particularly to a technique of disposing an inertia member on the electric motor side without increasing a space in the damper device.

### BACKGROUND ART

A damper device for a hybrid vehicle is known that is associated with an engine and an electric motor and that is disposed on a drive power transmission path between the engine and the electric motor. For example, this corresponds to a damper device described in Patent Document 1.

It is described that the damper device of Patent Document 1 includes a circular plate-shaped inertia member on the electric motor side and that the inertia member effectively suppresses transmission of torque fluctuation between the engine and the electric motor.

### PRIOR ART DOCUMENT

### Patent Document

Patent Document 1: Japanese Laid-Open Patent Publication No. 2009-292477

### SUMMARY OF THE INVENTION

### Problem to Be Solved by the Invention

However, since the inertia member is added on the electric motor side, a space necessary for housing the damper device is made larger by the inertia member and, therefore, the damper device as described above is problematically disadvantageous in terms of space.

The present invention was conceived in view of the situations and it is therefore an object of the present invention to provide a damper device having an inertia member added on the electric motor side to increase the inertia on the electric motor side and suppressing an increase in space housing the damper device.

### Means for Solving the Problem

To achieve the above object, the principle of the present invention provides a damper device (a) associated with an engine and an electric motor and disposed on a drive power transmission path between the engine and the electric motor, the damper device comprising: (b) a first inertia member coupled to a shaft of the engine; a first plate coupled to the first inertia member; a second plate coupled to the electric motor; a third plate coupled via a torque limiter to the second plate disposed rotatably relative to the first plate; and a damper spring disposed on a drive power transmission path between the third plate and the first plate, (c) the torque limiter being disposed with a second inertia member located on the outer circumferential side of the first inertia member.

### Effects of the Invention

According to the damper device configured as described above, since the torque limiter is provided with the second inertia member located on the outer circumferential side of the first inertia member, for example, the first inertia member can be disposed on the inner side of the damper device to dispose the second inertia member in a space in which the first inertia member is conventionally housed. Therefore, the second inertia member can be added on the electric motor side to increase the inertia on the electric motor side while suppressing an increase in space housing the damper device.

In one preferred form of the invention, (a) the torque limiter includes a pair of cover plates sandwiching outer circumferential portions of the second plate and the third plate via a spring and coupled to each other, and (b) the second inertia member is disposed at a position radially overlapping at least one of the pair of the cover plates, the spring, and the first inertia member. Therefore, even when the second inertia member is disposed on the torque limiter, an increase in space of the damper device can preferably be suppressed in the direction of an axial center of the damper device.

In another preferred form of the invention, (a) the second inertia member is disposed between the pair of the cover plates, and (b) the pair of the cover plates and the second inertia member are fastened by a first fastening member. Therefore, even when the second inertia member is provided in the torque limiter, an increase in space of the damper device can preferably be suppressed in the direction of the axial center of the damper device.

In a further preferred form of the invention, (a) the second plate includes a cylinder-shaped cylindrical portion protruded toward the first plate at a center portion of the second plate, and (b) a bearing is disposed between the cylindrical portion and the shaft of the engine. As a result, a load due to the addition of the second inertia member on the electric motor side is received and centered through the second plate and the bearing by the shaft of the engine and, therefore, the mass of the second inertia member can relatively easily be increased without improving the strength of a member on the electric motor side.

In a still further preferred form of the invention, (a) the first inertia member and the first plate are coupled by a second fastening member, (b) the torque limiter pinches an outer circumferential edge portion of the second plate and an outer circumferential edge portion of the third plate, and (c) the second plate includes an insert hole for a fastening tool fastening the second fastening member. Therefore, the damper device can be removed from the first inertia member by removing the second fastening member with the fastening tool inserted into the insert holes formed in the second plate.

In a yet further preferred form of the invention, (a) the cover plate on the first plate side of the pair of the cover plates includes a plate-shaped first plate portion formed in an outer circumferential portion of the cover plate and abutting on the second inertia member and a plate-shaped second plate portion formed in an inner circumferential portion of the cover plate and abutting on the spring, and (b) the second plate portion is bent toward the second plate relative to the first plate portion. Therefore, for example, when the second inertia member is removed from the torque limiter, the cover plate on the first plate side of the pair of the cover plates can be reversed to allow the first plate portion of the cover plate to abut on the cover plate on the opposed side to the cover plate on the first plate side of the pair of the cover plates and allow the second plate portion of the cover plate on the first plate side to abut on the spring. As a result, the cover plate on the first plate side of the pair of the cover plates can reversely be used so that the cover plate can be used in the both cases when the second inertia member is present and absent in the damper device.

### BRIEF DESCRIPTION OF THE DRAWINGS

FIG. 1 is a diagram for generally explaining a hybrid type vehicle power transmission device to which the present invention is preferably applied.

FIG. 2 is a cross-sectional view illustrating a configuration of a damper device included in the vehicle power transmission device shown in FIG. 1.

FIG. 3 is a cross-sectional view illustrating a configuration of a damper device in another example of the present invention, and the figure being corresponding to FIG. 2.

FIG. 4 is a cross-sectional view illustrating a configuration of a damper device in a further example of the present invention.

### MODES FOR CARRYING OUT THE INVENTION

Examples of the present invention will now be described in detail with reference to the drawings. In the following examples, the figures are simplified or deformed as needed and portions are not necessarily precisely shown in terms of dimension ratio, shape, etc.

### First Example

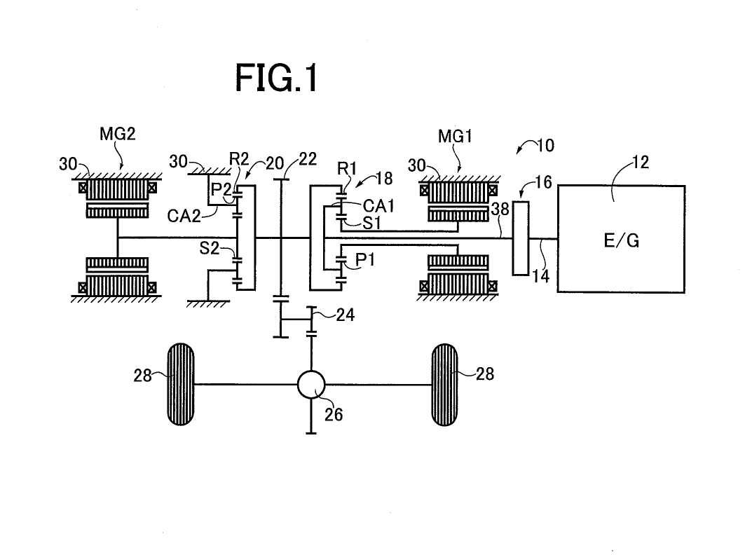

FIG. 1 is a diagram for generally explaining a hybrid type vehicle power transmission device 10 (hereinafter referred to as the power transmission device 10) to which the present invention is applied. As shown in FIG. 1, the power transmission device 10 includes an engine 12, a first planetary gear device 18 coupled via a damper device 16 to a crankshaft (shaft) 14 of the engine 12, a first electric motor (electric motor) MG1 coupled to the first planetary gear device 18, a second planetary gear device 20 acting as a reduction gear connected to the first planetary gear device 18, and a second electric motor MG2 coupled to the second planetary gear device 20 in a power transmissible manner.

The first planetary gear device 18 is made up of a single pinion type planetary gear device and includes a sun gear S1, a ring gear R1 coaxially arranged with the sun gear S1 and meshed with the sun gear S1 via a pinion gear P1, and a carrier CA1 supporting the pinion gear P1 in a rotatable and revolvable manner. The sun gear S1 of the first planetary gear device 18 is coupled to the first electric motor MG1; the carrier CA1 is coupled via the damper device 16 to the engine 12; and the ring gear R1 is operatively coupled via an output gear 22, a reduction gear device 24, and a final reduction gear 26 to right and left drive wheels 28.

The second planetary gear device 20 is made up of a single pinion type planetary gear device and includes a sun gear S2, a ring gear R2 coaxially arranged with the sun gear S2 and meshed with the sun gear S2 via a pinion gear P2, and a carrier CA2 supporting the pinion gear P2 in a rotatable and revolvable manner. The sun gear S2 of the second planetary gear device 20 is coupled to the second electric motor MG2; the carrier CA2 is coupled to a case 30 that is a non-rotating member; and the ring gear R2 is operatively coupled via the output gear 22, the reduction gear device 24, and the final reduction gear 26 to the right and left drive wheels 28 as is the case with the ring gear R1.

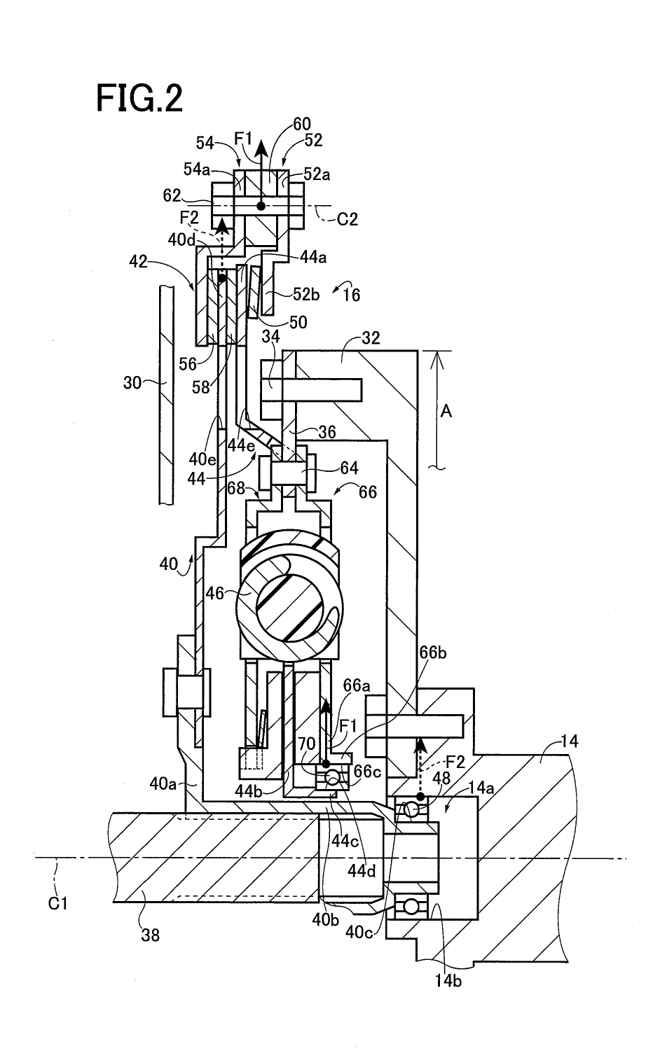

FIG. 2 is a cross-sectional view for explaining a configuration of the damper device 16 shown in FIG. 1 in detail. The damper device 16 is disposed around an axial center C1 between the engine 12 and the first planetary gear device 18, i.e., the first electric motor MG1 in a power transmittable manner.

As shown in FIG. 2, the damper device 16 includes a circular plate-shaped flywheel (first inertia member) 32 coupled to the crankshaft 14 of the engine 12, an input-side disk plate (first plate) 36 coupled to the flywheel 32 by a plurality of damper fastening bolts (second fastening members) 34, a hub plate (second plate) 40 coupled non-rotatably to a transaxle input shaft 38 coupled to the carrier CA1 of the first planetary gear device 18, an output-side disk plate (third plate) 44 coupled via a torque limiter mechanism (torque limiter) 42 to the hub plate 40, and a coil-shaped damper spring 46 disposed on a drive power transmission path between the output-side disk plate 44 and the input-side disk plate 36 and elastically deformed depending on a relative rotational displacement between the output-side disk plate 44 and the input-side disk plate 36. The damper device 16 has a structure transmitting a drive force from the engine 12 in the order of, for example, the flywheel 32, the input-side disk plate 36, the damper spring 46, the output-side disk plate 44, the torque limiter mechanism 42, the hub plate 40, and the transaxle input shaft 38.

The hub plate 40 is a substantially circular plate-shaped member extended from an end portion of the transaxle input shaft 38 in the direction approaching the torque limiter mechanism 42, and the hub plate 40 is provided with a cylindrical portion 40b cylindrically protruded from a center portion 40a of the hub plate 40 integrally in the direction approaching the input-side disk plate 36, i.e., toward an end portion of the crankshaft 14. The hub plate 40 allows the end portion of the transaxle input shaft 38 to be spline-fitted inside the cylindrical portion 40b of the hub plate 40. A fitting hole 14a is drilled in the end portion of the crankshaft 14 and a first bearing (bearing) 48 is interposed between an inner circumferential surface 14b of the fitting hole 14a and an outer circumferential surface 40c of an end portion of the cylindrical portion 40b of the hub plate 40.

The torque limiter mechanism 42 includes a pair of cover plates 52 and 54 sandwiching an outer circumferential edge portion 40d of the hub plate 40 and an outer circumferential edge portion 44a of the output-side disk plate 44 via a disk spring (spring) 50 and coupled to each other, and a pair of annular friction materials 56 and 58 respectively sandwiched between the cover plate 54 and the outer circumferential edge portion 40d of the hub plate 40 and between the outer circumferential edge portion 40d of the hub plate 40 and the outer circumferential edge portion 44a of the output-side disk plate 44. The torque limiter mechanism 42 pinches the outer circumferential edge portion 40d of the hub plate 40 and the outer circumferential edge portion 44a of the output-side disk plate 44 via the friction materials 56 and 58 by a biasing force of the disk spring 50 and, if the torque transmitted from the output-side disk plate 44 to the hub plate 40 exceeds a preset limit torque, the outer circumferential edge portion 44a of the output-side disk plate 44 slides relative to the outer circumferential edge portion 40d of the hub plate 40 to prevent transmission of an excessive torque to the hub plate 40.

The torque limiter mechanism 42 is disposed with an annular inertia ring (second inertia member) 60 located on the outer circumferential side of the flywheel 32. Therefore, the torque limiter mechanism 42 with the inertia ring 60 fixed thereto is disposed outside the flywheel 32, the input-side disk plate 36, and the damper fastening bolts 34 and is disposed by utilizing a space over the outer circumference of the flywheel 32.

The inertia ring 60 is disposed between outer circumferential portions of a pair of the cover plates 52 and 54, and a pair of the cover plates 52 and 54 and the inertia ring 60 are fastened by an inertial ring fastening bolt (first fastening member) 62. The inertia ring 60 is disposed at a position radially overlapping the cover plate 52 and the disk spring 50. The inertial ring fastening bolt 62 is fastened from the transaxle side and can be removed from the transaxle side.

The output-side disk plate 44 is a substantially circular plate-shaped member extended from the outside of the end portion of the transaxle input shaft 38 in the direction approaching the torque limiter mechanism 42, and is integrally provided with a cylindrical portion 44c cylindrically protruded from a center portion 44b of the output-side disk plate 44 in the direction approaching the crankshaft 14. The input-side disk plate 36 integrally includes a pair of substantially circular plate-shaped side plates 66 and 68 fixed to an inner circumferential portion of the input-side disk plate 36 by a rivet 64. The side plate 66 is integrally provided with a cylindrical portion 66b cylindrically protruded from a center portion 66a of the side plate 66 in the direction approaching the crankshaft 14, and a second bearing 70 is interposed between an inner circumferential surface 66c of the cylindrical portion 66b and an outer circumferential surface 44d of the cylindrical portion 44c of the output-side disk plate 44.

The hub plate 40 is penetrated by six insert holes 40e for inserting a fastening tool not shown fastening a plurality of the (in this example, six) damper fastening bolts 34 between the center portion 40a and the outer circumferential edge portion 40d. The output-side disk plate 44 has six communication holes 44e formed in communication with the six insert holes 40e formed in the hub plate 40 between the center portion 44b and the outer circumferential edge portion 44a.

With regard to the damper device 16 configured as above, the damper device 16 can be removed from the flywheel 32 by removing the damper fastening bolts 34 with the fastening tool inserted from the transaxle side into the insert holes 40e formed in the hub plate 40. If the outer circumferential edge portion 44a of the output-side disk plate 44 slides relative to the outer circumferential edge portion 40d of the hub plate 40 to change the phase of the insert holes 40e relative to the communication holes 44e and the damper fastening bolts 34 cannot be removed in the torque limiter mechanism 42, the inertial ring fastening bolt 62 can be loosened to make the output-side disk plate 44 and the hub plate 40 relatively rotatable so as to match the positions of the communication holes 44e of the output-side disk plate 44 and the insert holes 40e of the hub plate 40 and, therefore, the damper device 16 can be removed from the flywheel 32 as described above.

Since the damper device 16 has the inertia ring 60 disposed on the torque limiter mechanism 42, i.e., the inertia ring 60 disposed on the electric motor MG1 side, a force F1, i.e., an unbalance load F1, acts on the inertia ring 60 in the direction of an arrow indicated by a solid line as shown in FIG. 2 and a force F2, i.e., an eccentric load F2, acts on the torque limiter mechanism 42 in the direction of an arrow indicated by a broken line. Since for example, the unbalance load F1 is input through the output-side disk plate 44 and the second bearing 70 toward the engine 12 and the eccentric load F2 is input through the hub plate 40 and the first bearing 48 toward the engine 12 in the damper device 16, excessive load input to the transaxle input shaft 38 due to the inertia ring 60 disposed on the electric motor MG1 side is preferably suppressed.

As described above, according to the damper device 16 of this example, since the torque limiter mechanism 42 is provided with the inertia ring 60 located on the outer circumferential side of the flywheel 32, for example, the flywheel 32 can be disposed on the inner side of the damper device 16 to dispose the inertia ring 60 in a space in which the flywheel 32 etc., are conventionally housed. Therefore, the inertia ring 60 can be added on the electric motor MG1 side to increase the inertia on the electric motor MG1 side while suppressing an increase in space housing the damper device 16. Since the inertia ring 60 is disposed on the outer circumferential side of the flywheel 32, the mass of the inertia ring 60 is easily increased and the inertia on the electric motor MG1 side is easily increased.

According to the damper device 16 of this example, the torque limiter mechanism 42 includes a pair of the cover plates 52 and 54 sandwiching the outer circumferential edge portion 40d of the hub plate 40 and the outer circumferential edge portion 44a of the output-side disk plate 44 via the disk spring 50 and coupled to each other, and the inertia ring 60 is disposed at a position radially overlapping the cover plate 52 and the disk spring 50. Therefore, even when the inertia ring 60 is disposed on the torque limiter mechanism 42, an increase in space of the damper device 16 can preferably be suppressed in the direction of the axial center C1 of the damper device 16.

According to the damper device 16 of this example, the inertia ring 60 is disposed between a pair of the cover plates 52 and 54, and the pair of the cover plates 52 and 54 and the inertia ring 60 are fastened by the inertial ring fastening bolt 62. Therefore, even when the inertia ring 60 is provided in the torque limiter mechanism 42, an increase in space of the damper device 16 can preferably be suppressed in the direction of the axial center C1 of the damper device 16.

According to the damper device 16 of this example, the cylinder-shaped cylindrical portion 40b protruded toward the input-side disk plate 36 is included at the center portion 40a of the hub plate 40 and the first bearing 48 is disposed between the cylindrical portion 40b of the hub plate 40 and the crankshaft 14 of the engine 12. As a result, the eccentric load F2 due to the addition of the inertia ring 60 on the electric motor MG1 side is received and centered through the hub plate 40 and the first bearing 48 by the crankshaft 14 of the engine 12 and, therefore, the mass of the inertia ring 60 can relatively easily be increased without improving the strength of a member on the electric motor MG1 side.

According to the damper device 16 of this example, the flywheel 32 and the input-side disk plate 36 are coupled by a plurality of the damper fastening bolts 34, and the torque limiter mechanism 42 pinches the outer circumferential edge portion 40d of the hub plate 40 and the outer circumferential edge portion 44a of the output-side disk plate 44 while the hub plate 40 is disposed with the insert holes 40e for the fastening tool fastening the damper fastening bolts 34. Therefore, the damper device 16 can be removed from the flywheel 32 by removing a plurality of the damper fastening bolts 34 with the fastening tool inserted into the insert holes 40e formed in the hub plate 40.

Another example of the present invention will be described. In the following description, the portions common to the examples are denoted by the same reference numerals and will not be described.

### Second Example

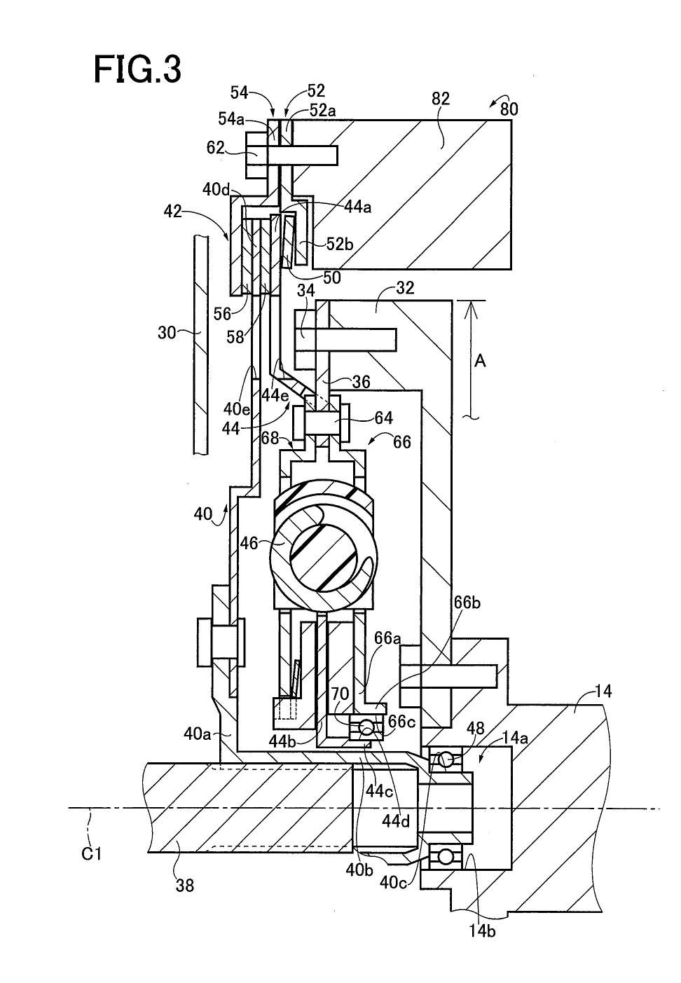

As shown in FIG. 3, a damper device 80 of this example is different in that the torque limiter mechanism 42 is disposed with an inertia ring 82 having the mass larger than that of the inertia ring 60 of the damper device 16 of the first example described above and has substantially the same configuration except this point.

The inertia ring 82 is formed into an annular shape and is disposed on the outer circumferential side of the flywheel 32. Therefore, the torque limiter mechanism 42 with the inertia ring 82 fixed thereto is disposed outside the flywheel 32, the input-side disk plate 36, and the damper fastening bolts 34 and is disposed by utilizing a space over the outer circumference of the flywheel 32. The inertia ring 82 is disposed at a position radially overlapping the cover plate 52 and the flywheel 32.

Since the damper device 80 configured as described above is disposed with the inertia ring 82 having the mass larger than that of the inertia ring 60 of the first example and enabling the setting of relatively large inertia on the electric motor MG1 side, the damper device 80 is preferably applicable when, for example, the three-cylinder or two-cylinder engine 12 has a large compelling force.

### Third Example

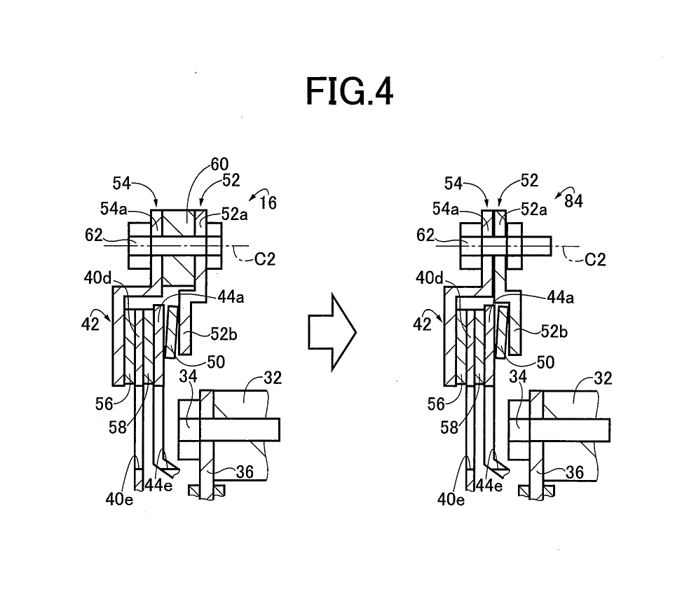

As shown on the right side of FIG. 4, a damper device 84 of this example is different in that the inertia ring 60 (see the left side of FIG. 4) of the damper device 16 of the first example is not attached and has substantially the same configuration except this point.

As shown on the left side of FIG. 4, in a pair of the cover plates 52 and 54 of the first example, the annular cover plate 52 closer to the input-side disk plate 36 integrally includes a plate-shaped first plate portion 52a formed in an outer circumferential portion of the cover plate 52 and abutting on the inertia ring 60 and a plate-shaped second plate portion 52b formed in an inner circumferential portion of the cover plate 52 and abutting on the disk spring 50, and the second plate portion 52b is bent toward the hub plate 40 relative to the first plate portion 52a in the direction of an axial center C2 of the inertial ring fastening bolt 62.

In the damper device 84 of this example, as shown on the right side of FIG. 4, a pair of the cover plates 52 and 54 is coupled by the inertial ring fastening bolt 62 with the cover plate 52 reversed to allow the first plate portion 52a of the cover plate 52 to abut on an outer circumferential portion 54a of the cover plate 54 and allow the second plate portion 52b of the cover plate 52 to abut on the disk spring 50. The cover plate 52 is bent such that the position of the second plate portion 52b abutting on the disk spring 50 is not changed when the first plate portion 52a is allowed to abut on the inertia ring 60 as in the first example and to abut on the outer circumferential portion 54a of the cover plate 54 as in this example. In the damper device 80 of the second example, the cover plate 52 is reversely used as in the damper device 84 of this example when the inertia ring 82 is attached to the torque limiter mechanism 42.

As described above, according to the damper device 84 of this example, the cover plate 52 integrally includes the plate-shaped first plate portion 52a formed in the outer circumferential portion of the cover plate 52 and abutting on the inertia ring 60 and the plate-shaped second plate portion 52b formed in the inner circumferential portion of the cover plate 52 and abutting on the disk spring 50, and the second plate portion 52b is bent toward the hub plate 40 relative to the first plate portion 52a. Therefore, for example, when the inertia ring 60 is removed from the torque limiter mechanism 42, the cover plate 52 can be reversed to allow the first plate portion 52a of the cover plate 52 to abut on the outer circumferential portion 54a of the cover plate 54 and allow the second plate portion 52b of the cover plate 52 to abut on the disk spring 50. As a result, the cover plate 52 can reversely be used so that the cover plate 52 can be used in the both cases when the inertia ring 60 is present and absent in the damper device 16 and the damper device 84.

Although the examples of the present invention have been described in detail with reference to the drawings, the present invention is applied in other forms.

Although the damper device 16 of the first example has the inertia ring 60 disposed at a position radially overlapping the cover plate 52 and the disk spring 50 and the damper device 80 of the second example has the inertia ring 82 disposed at a position radially overlapping the cover plate 52 and the flywheel 32 in the examples, the inertia rings 60, 82 may be disposed at a position radially overlapping at least one of the pair of the cover plates 52 and 54, the disk spring 50, and the flywheel 32.

Although an outermost diameter A of the flywheel 32 is disposed on the radially inner side than the inertia rings 60, 82 in the examples, the outermost diameter A of the flywheel 32 may be disposed on the radially inner side than the torque limiter mechanism 42, for example.

The above description is merely an embodiment and the present invention may be implemented in variously modified and improved forms based on the knowledge of those skilled in the art.

### NOMENCLATURE OF ELEMENTS

12: engine

14: crankshaft (shaft of the engine)

16, 80, 84: damper device

32: flywheel (first inertia member)

34: damper fastening bolt (second fastening member)

36: input-side disk plate (first plate)

40: hub plate (second plate)

40a: center portion

40b: cylindrical portion

40d: outer circumferential edge portion

40e: insert hole

42: torque limiter mechanism (torque limiter)

44: output-side disk plate (third plate)

44a: outer circumferential edge portion

46: damper spring

48: first bearing (bearing)

50: disk spring (spring)

52, 54: a pair of cover plates

52a: first plate portion

52b: second plate portion

60, 82: inertia ring (second inertia member)

62: inertia ring fastening bolt (first fastening member)

MG1: first electric motor (electric motor)

1. A damper device disposed on a drive power transmission path between an engine an electric motor in a power transmission device including the engine and the electric motor,
the damper device comprising: a first inertia member coupled to a shaft of the engine; a first plate coupled to the first inertia member; a second plate coupled to the electric motor and disposed rotatably relative to the first plate; a third plate coupled via a torque limiter to the second plate; and a damper spring disposed on a drive power transmission path between the third plate and the first plate,
the torque limiter being disposed with a second inertia member located on the outer circumferential side of the first inertia member and radially overlapping with the first inertia member in the overall width dimension of the first inertia member in an axial direction thereof.

2. The damper device of claim 1, wherein
the torque limiter includes a pair of cover plates sandwiching outer circumferential edge portions of the second plate and the third plate via a spring and coupled to each other, and wherein
the second inertia member is disposed at a position radially overlapping at least one of the pair of the cover plates, the spring, and the first inertia member.

3. (canceled)

4. The damper device of claim 1, wherein
the second plate includes a cylinder-shaped cylindrical portion protruded toward the first plate at a center portion of the second plate, and wherein
a bearing is disposed between the cylindrical portion and the shaft of the engine.

5. The damper device of claim 1, wherein
the first inertia member and the first plate are fastened by a second fastening member, wherein
the torque limiter pinches an outer circumferential edge portion of the second plate and an outer circumferential edge portion of the third plate, and wherein
the second plate includes an insert hole for a fastening tool fastening the second fastening member.

6. (canceled)
